(19) United States
(12) Patent Application Publication
(10) Pub. No.: US 2003/0209259 A1
(43) Pub. Date: Nov. 13, 2003

(54) Method for decreasing wafer scrap rate for a chemical treatment apparatus

(76) Inventors: Hsuan-Sheng Tung, Yung Kang City (TW); Hsin-Ta Chien, Chung Li City (TW); Jui-Ping Li, Yi Lan (TW)

Correspondence Address: BAKER & BOTTS, 30 ROCKEFELLER PLAZA, NEW YORK, NY, 10112

(21) Appl. No.: 10/141,994

(22) Filed: May 8, 2002

(51) Int. Cl. B08B 3/04

(52) U.S. Cl. 134/18

(57) ABSTRACT

The present invention, a method for decreasing wafer scrap rate in the chemical treatment apparatus, performs the controls of the robots, the drain valve of the chemical treatment bath and the supply valve of ultra-pure water to decrease the reaction rate between a wafer and the chemical treatment liquid, wherein the controls are performed in accordance with different abnormal factors, such as the abnormal conditions of power supply and the robots. The present invention can be used in the control system, such as by writing a recipe added to the control system. When an alarm occurs, the control system can execute the recipe to decrease the wafer damage. According to the present invention, the method for decreasing wafer scrap rate in the chemical treatment apparatus has the advantages of saving the wafer-manufacturing cost and increasing the wafer-manufacturing yield.

### FIELD OF THE INVENTION

The present invention relates to the wafer manufacturing process using a chemical treatment apparatus, and more particularly, to a method for decreasing wafer scraps that are resulted from the abnormal chemical treatment apparatus.

### BACKGROUND OF THE INVENTION

The wet processes used in the semiconductor manufacturing process, mainly include the wafer cleaning and the wet etching, and the apparatuses used in the wet processes are called wet benches, wherein the wet benches generally include chemical bathes, rinsing bathes, and dryer bathes. Generally, the chemical treatment apparatuses are much bigger than the semiconductor apparatuses in size. In consideration of the effective available area in a clean room, the chemical treatment usually is performed with a unit of 50 wafers in the apparatus, and a few robots are used among the chemical bathes, the rinsing bathes, and the dryer bathes, for transporting wafers in fabrication, wherein the number of robots used is decided by the features and number of the chemicals treatment apparatuses.

FIG. 1 illustrates a schematic diagram showing a conventional chemical treatment apparatus. Referring to FIG. 1, a chemical bath includes an inner bath 12 and an outer bath 14, and a wafer 18 is processed with a treatment in the inner bath 12 having chemical treatment liquid 16, wherein the chemical treatment liquid 16 is mobile. After the chemical treatment liquid 16 fills up the inner bath 12, the chemical treatment liquid 16 will overflow into the outer bath 14. Then, the chemical treatment liquid 16 can be drained out from the drain piping of the outer bath 14, and the chemical treatment liquid 16 can be recycled back to the inner bath 12 for reuse, after the chemical treatment liquid 16 is pressurized by a pump 20, and then heated by a heater 22, and thereafter filtered by a filter 24.

The chemical treatment liquid 16 commonly used in a chemical treatment apparatus can be for example, sulfuric acid hydrogen peroxide mixture (H₂SO₄+H₂O₂; SPM), dilute hydrofluoric acid (DHF), buffer oxide etching (BOE) of a hydrofluoric acid ammonium fluoric mixture (HF+NH₄F), ammonium hydrogen peroxide mixture (NH₄OH+H₂O₂; APM), or hydrochloric acid peroxide mixture (HCl+H₂O₂; HPM), etc. While different chemical treatment liquids are used in the chemical treatment apparatus, different process parameters, such as soaking time, soaking temperature, and circulation flow rate in the chemical treatment bathes, have to be set for performing the chemical treatment process.

Robot motions and the process parameters of chemical treatment bathes will affect the wafer quality after the chemical treatment process is performed. In addition, if the robots or the chemical treatment baths have abnormal conditions, wafers may fail to meet the quality standard after the chemical treatment process is performed, and the wafers then has to be scrapped, and thus the yield is reduced. For example, in a DHF process, if the process parameters of the chemical treatment apparatuses are changed, the thickness of SiO2 layer on the wafers processed in the chemical treatment baths will vary due to the server change of the HF etching rate, so that the critical dimensions of integrated circuit will not meet the standard. Therefore, the aforementioned wafers will be useless in the subsequent process, and have to be discarded.

### SUMMARY OF THE INVENTION

In view of the conventional background, once the robots or the chemical treatment apparatuses has abnormal conditions; the wafers in the chemical treatment process always have to be discarded, so that the yield is reduced. Hence, one aspect of the present invention is to provide a method for decreasing wafer scrap rate, when the robots are operated normally but the chemical treatment apparatus abnormally. Besides, the present invention also provides the other method suitable for use in the process containing HF for decreasing wafer scrap rate, when the chemical treatment apparatuses are in an abnormal condition.

According to the aforementioned aspects, the method for decreasing wafer scrap rate for a chemical treatment apparatus comprises: providing a chemical treatment bath, wherein the chemical treatment bath has an inner bath connected with a quick drain valve and an outer bath connected with a drain valve, and the chemical treatment bath has chemical treatment liquid; performing a chemical treatment process by putting a wafer into the chemical treatment liquid; when an alarm occurs, opening the quick drain valve of the inner bath and the drain valve of the outer bath for draining the chemical treatment liquid out of the chemical treatment bath; determining if a surface of the remaining chemical treatment liquid is lower than a standard surface; and if the surface of the remaining chemical treatment liquid is lower than the standard surface, closing the quick drain valve of the inner bath and opening a supply valve of ultra-pure water to supply ultra-pure water into the inner bath. In addition, after an alarm is occurred, another method of the present invention further comprises opening the drain valve of the outer bath and the supply valve of ultra-pure water at the same time, for draining out the chemical treatment liquid from the drain valve of the outer bath and pouring the ultra-pure water into the inner bath of the chemical treatment bath. Further, another method of the present invention also comprises using a robot to move the wafers into a rinsing bath, for preventing the wafers from being damaged by the chemical treatment liquid.

According to the present invention, the method for decreasing wafer scrap rate in the chemical treatment apparatus has the advantages of: saving the wafer manufacturing cost and improving the manufacturing yield.

### BRIEF DESCRIPTION OF THE DRAWINGS

The above features of the present invention will be more clearly understood from consideration of the following descriptions in connection with accompanying drawings in which:

FIG. 1 illustrates a schematic diagram showing a conventional chemical treatment apparatus;

FIG. 2 illustrates a flow chart showing the operation of the method for decreasing wafer scrap rate in the chemical treatment apparatus, according to an embodiment of the present invention;

FIG. 3a to FIG. 3b illustrate a schematic diagram showing the apparatus operation of the method for decreasing wafer scrap rate in the chemical treatment apparatus according to FIG. 2;

FIG. 3c to FIG. 3e illustrate a schematic diagram showing the process of the rinsing bath, according to an embodiment of the present invention;

FIG. 4 illustrates a flow chart showing the operation of the method for decreasing wafer scrap rate in the chemical treatment apparatus, according to the other embodiment of the present invention;

FIG. 5a to FIG. 5b illustrate a schematic diagram showing the apparatus operation of the method for decreasing wafer scrap rate in the chemical treatment apparatus, according to FIG. 4;

FIG. 6 illustrates a flow chart showing the operation of the method for decreasing wafer scrap rate, in the chemical treatment apparatus, according to the other embodiment of the present invention; and

FIG. 7 illustrates a schematic diagram showing the apparatus operation of the method for decreasing wafer scrap rate in the chemical treatment apparatus, according to FIG. 6.

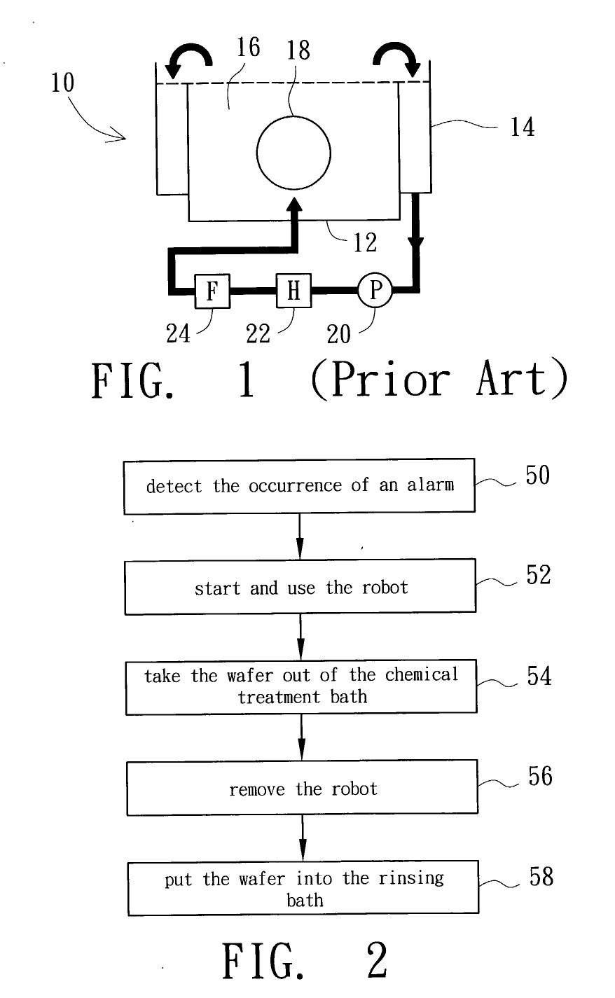

### DETAILED DESCRIPTION OF THE PREFERRED EMBODIMENT

The reasons for the wafers scrapped in the general chemical treatment processes (such as the wafer rinsing process and the wet etching process) are such as the abnormal soaking time, the abnormal soaking temperature, the abnormal circulation flow rate of chemical treatment liquid, the abnormal power interruption, and the abnormal robot operation, etc. No matter what the reasons are, the device dimensions on the wafers processed in the chemical treatment bath are very likely to fail in meeting the standard due to the change of the etching rate or the rinsing rate, wherein the unqualified wafers can not be used in the subsequent processes. The present invention discloses three methods, and the methods can be applied in the chemical treatment process for decreasing the wafer scrap rate in accordance with the actual processes and the needs of products.

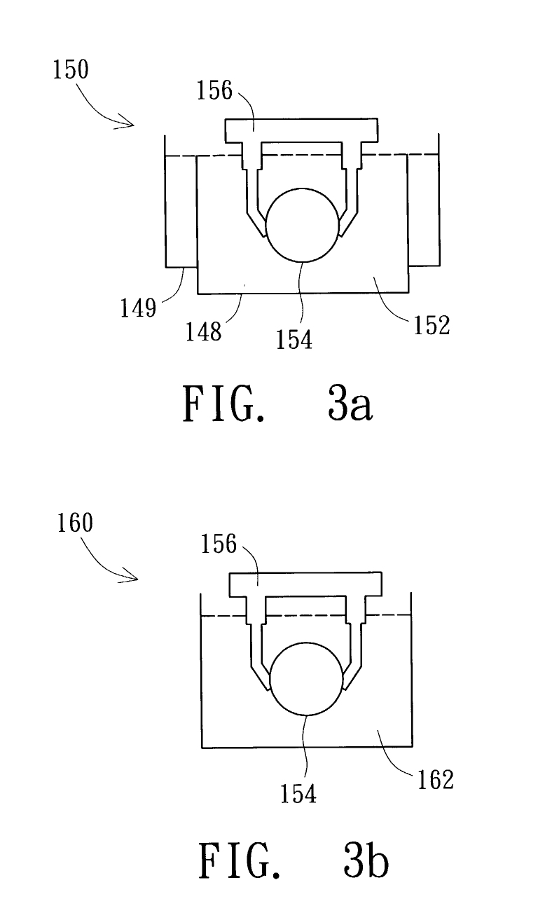

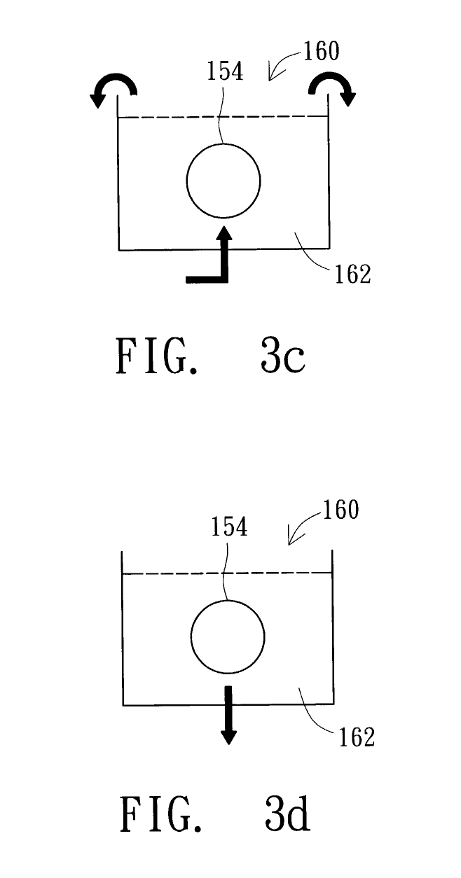

FIG. 2 illustrates a flow chart showing the operation of the method for decreasing wafer scrap rate in the chemical treatment apparatus according to an embodiment of the present invention, and FIG. 3a to FIG. 3b illustrate a schematic diagram showing the apparatus operation of the method for decreasing wafer scrap rate in the chemical treatment apparatus according to FIG. 2. Referring to FIG. 2, FIG. 3a, and FIG. 3b, generally, a chemical treatment bath 150 includes an outer bath 149 and an inner bath 148, and a wafer 154 is processed by the chemical treatment process in the inner bath 148, wherein chemical treatment liquid 152 is contained in the inner bath 148, and poured into the inner bath 148 continuously through piping. When the chemical treatment liquid 152 fills up the inner bath 148, the chemical treatment liquid 152 will overflow into the outer bath 149. Then, after processed with the steps of pressurizing, heating, and filtering, the chemical treatment liquid can be recycled to the inner bath 148. The control system of the chemical treatment process is used to monitor the wafer manufacture status, and to provide an alarm if the abnormal conditions are detected.

If the control system detects the occurrence of an alarm 50 and the alarm 50 is caused by the abnormal parameter status of the chemical treatment bath such as the abnormal soaking time, the abnormal soaking temperature, or the abnormal circulation flow rate of chemical treatment liquid. If the power supply and robots between the apparatuses are still operated normally, then the present invention sequentially performs steps 52, 54, 56 and 58: using the robot 156 to take the wafer out of the chemical treatment bath 150 and then to put into the rinsing bath collocated with the chemical treatment bath 150. For decreasing the wafer scrap rate, the present invention uses robots to put wafers into the rinsing bath 160, thereby decreasing the chemical reaction rate of chemical treatment liquid performed on the wafers, so that the damage onto the wafers can be stopped.

Since the chemical treatment bath 150 can be collocated with the rinsing bath 160 having different rinsing steps according to the chemical treatment liquid 152 therein, the present invention is not limited thereto, and the rinsing liquid and the rinsing steps of the rinsing bath can be varied due to the different manufacturing processes, apparatuses or products. Generally, the wafer fabrication factories use ultra-pure water 162 as the rinsing liquid of the rinsing bath. For instance, the chemical treatment bath 150 having the chemical treatment liquid composed of SPM, HPM, or APM is usually collocated with the rinsing bath 160 having the quick dump rinsing system, such as shown in FIG. 3c to FIG. 3e. Referring to FIG. 3c to FIG. 3e, when a wafer 154 is put into the rinsing bath 160, the ultra-pure water 162 is poured into and overflows out of the rinsing bath 160 continuously. Next, the supply valve of the ultra-pure water 162 is closed, and the ultra-pure water 162 in the rinsing bath 160 is drained out totally. Then, the ultra-pure water 162 is poured into the rinsing bath 160 again for rinsing the wafer 154. Further, the chemical treatment bath 150 having the chemical treatment liquid composed of HF, such as DHF and BOE, is collocated with the rinsing bath 160 having the overflow based system, such as shown in FIG. 3c. The overflow based system keeps pouring the ultra-pure water 162 until the step of rinsing wafer is completed.

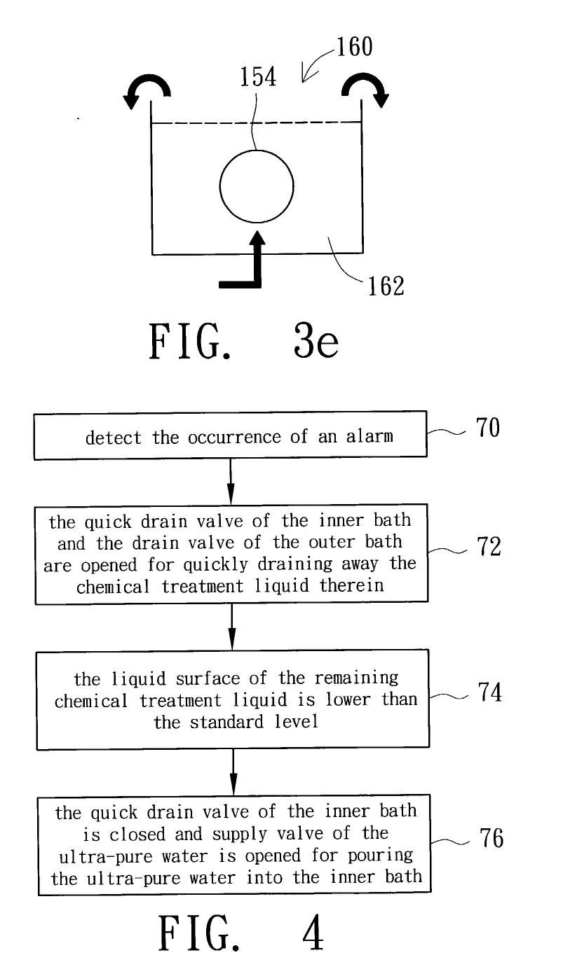

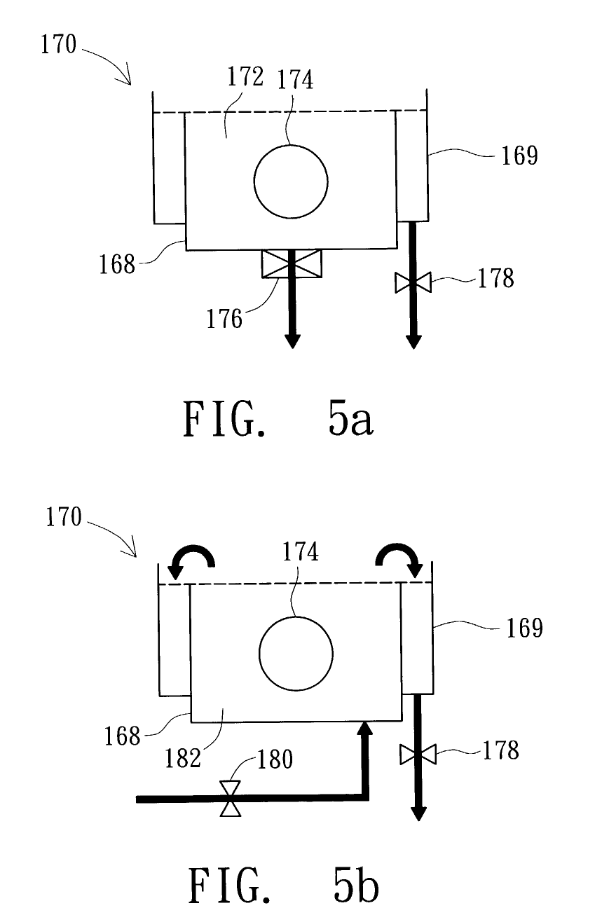

On the other hand, if the alarm is resulted from the abnormal status of the power supply or robots, the aforementioned method for decreasing wafer scrap rate in the chemical treatment apparatus cannot be used. Hence, the present invention provides another method for decreasing wafer scrap rate in the chemical treatment apparatus, wherein the method is not only suitable for use in the abnormal statuses of power supply and robots, but also for use in the abnormal statuses of process parameters of the chemical treatment baths, such as the abnormal soaking time, the abnormal soaking temperature, and the abnormal circulation flow rate of chemical treatment liquid. Referring to FIG. 4, FIG. 5a, and FIG. 5b, if the control system detects the occurrence of an alarm 70, the present invention sequentially performs steps 72, 74, and 76. First, in the chemical treatment bath 170, the quick drain valve 176 of the inner bath 168 and the drain valve 178 of the outer bath 169 are opened, for quickly draining away the chemical treatment liquid 172 therein. Next, a lower level indicating sensor installed in the chemical treatment bath 170 detects if the liquid surface of the remaining chemical treatment liquid 172 is lower than the standard level. Or, a drain time of the chemical treatment liquid 172 can be set in the chemical treatment process, so that it can be known that all the chemical treatment liquid 172 is drained out of the chemical treatment bath 170 in the drain time. After the chemical treatment liquid 172 is totally drained out of the chemical treatment bath 170, the quick drain valve 176 of the inner bath 168 is closed, and the supply valve 180 of the ultra-pure water 182 is opened for pouring the ultra-pure water 182 into the inner bath 168.

In the aforementioned method of the present invention, the quick drain valve 176 should be used in the inner bath 168, in order to drain the chemical treatment liquid 172 in the chemical treatment bath 170 quickly, and the preferred drain time is less than 1 min. In a preferred embodiment, the volume of the inner bath 168 of the chemical treatment bath 170 is about 30 liters, and the diameter of the drain valve is about ¾ inches, so that the drain time of the chemical treatment liquid 172 is about 3 min. But the present invention uses the quick drain valve 176 having the diameter larger than 1 inch, and the drain time of the chemical treatment liquid 172 can be reduced to less than 30 sec, so that the damage of wafer 174 caused by the chemical treatment liquid 172 is decreased accordingly. In the instance of the DHF chemical treatment bath, it is assumed that the volume of the inner bath is 30 liters; the process temperature is 25° C.; the process concentration is 100:1 (0.5%); and the etching rate of the SiO₂ layer of the wafer is 31.5 Å per min. According to the types of drain valve and the drain time, the etching thickness of the SiO₂ layer is also varied, such as shown in the following table:

| kind of drain | draining time | etching thickness (Å) |
|---|---|---|
| drain valve | 3 min | 94.5 |
| quick drain valve | 0.5 min | 15.75 |

Therefore, it can be known that the present invention choosing the quick drain valve 176 can reduce the damage onto the wafer 174 caused by the chemical treatment liquid 172. Besides, the flow rate and the diameter of the pipe carrying the ultra-pure water 182 are matched with the volume of the inner bath 168 of the chemical treatment bath 170, the general diameter thereof is 4/8 inches, and the flow rate thereof is 10 liters per minute. But in the preferred embodiment of the present invention, the diameter of the pipe carrying the ultra-pure water 182 is larger than 4/8 inches, and the flow rate is larger to 30 liters per minute. If the flow rate of the ultra-pure water 182 is increased to 45 liters per minute, then the replacement time can be reduced to as low as 0.7 min. In the present invention, the purpose of using the lager flow rate and the large pipe diameter is to reduce the residue of the chemical treatment liquid 172 on the wafer 174 surface, thereby decreasing the wafer 174 roughness resulted from the chemical reaction.

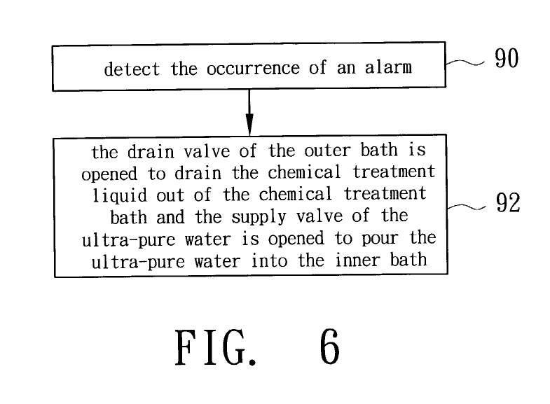

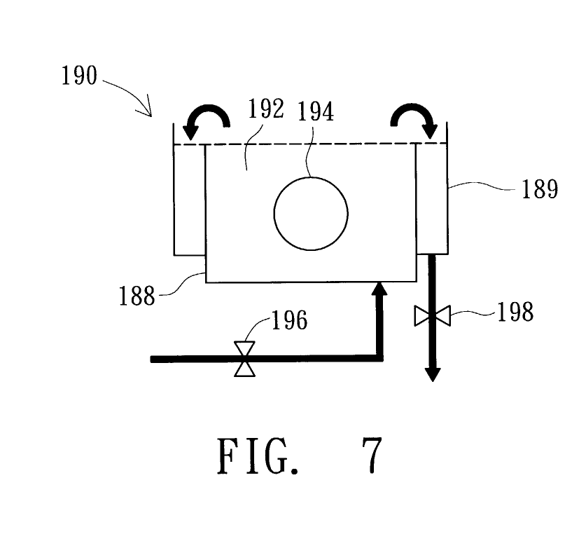

Further, with respect to the chemical treatment bath having the chemical treatment liquid composed of HF, such as DHF and BOE, the present invention also provides a method for decreasing wafer scrap rate, and the method id suitable for use in the abnormal statuses of power supply, robots, soaking time, soaking temperature, and the circulation flow rate of chemical treatment liquid. Referring to FIG. 6 and FIG. 7, if the control system detects the occurrence of an alarm 90, the present invention performs the step 92 for reducing wafer scrap rate. In step 92, the drain valve 198 connected to the outer bath 189 of the chemical treatment bath 190 is opened to drain the chemical treatment liquid 192 out of the chemical treatment bath 190, and the supply valve 196 of the ultra-pure water is opened to pour the ultra-pure water into the inner bath 188 of the chemical treatment bath 190. In the present invention, the ultra-pure water is poured into the inner bath 188 continuously, so that the chemical treatment liquid 192 is diluted and drained at the same time, and finally, the chemical treatment liquid 192 is only filled with the molecules of the ultra-pure water. It is not proper to expose the wafer 194 processed in the chemical treatment liquid 192 composed of HF solution to air, so that the present embodiment does not drain out all the chemical treatment liquid, like the former embodiment, but dilutes the concentration of chemical treatment liquid continuously with the ultra-pure water poured. Hence, the present embodiment can also decreases the chemical reaction rate and the wafer damage.

By applying the method of the present invention for decreasing wafer scrap rate in the wafer-manufacturing factory, wafer scrap rate is decreased essentially. For example, by writing the methods of the present invention into a recipe added in the control system of the chemical treatment apparatuses, the wafer scarp rate can be dramatically reduced. Since the fabrication of wafer is very expensive, it can save a lot of expenditure to decrease the wafer scrap rate. Therefore, the present invention is very useful in the application and the development of wafer manufacture.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for decreasing wafer scrap rate in the chemical treatment apparatus, comprising:
providing a chemical treatment bath, wherein the chemical treatment bath has an inner bath connected with a quick drain valve and an outer bath connected with a drain valve, and the chemical treatment bath has a chemical treatment liquid contained;
performing a chemical treatment process by putting a wafer into the chemical treatment liquid;
when an alarm occur, opening the quick drain valve of the inner bath and the drain valve of the outer bath for draining the chemical treatment liquid out of the chemical treatment bath;
determining if a surface of a remaining portion of the chemical treatment liquid is lower than a standard surface; and
if the surface of the remaining portion of the chemical treatment liquid is lower than the standard surface, closing the quick drain valve of the inner bath and opening a supply valve of ultra-pure water to supply the ultra-pure water into the inner bath.

2. The method of claim 1 for decreasing wafer scrap rate in the chemical treatment apparatus, wherein the chemical treatment liquid is composed of the material selected from a group consisting of sulfuric acid hydrogen peroxide mixture (H₂SO₄+H₂O₂; SPM), dilute hydrofluoric acid (DHF), buffer oxide etching (BOE) of a hydrofluoric acid ammonium fluoric mixture (HF+NH₄F), ammonium hydrogen peroxide mixture (NH₄OH+H₂O₂; APM), and hydrochloric acid peroxide mixture (HCl+H₂O₂; HPM).

3. The method of claim 1 for decreasing wafer scrap rate in the chemical treatment apparatus, wherein the volume of the chemical treatment bath is about 30 liters.

4. The method of claim 1 for decreasing wafer scrap rate in the chemical treatment apparatus, wherein the diameter of the quick drain valve is larger than about 1 inch.

5. The method of claim 3 for decreasing wafer scrap rate in the chemical treatment apparatus, wherein the supply valve of the ultra-pure water has a supply rate larger than about 30 liters per minute.

6. The method of claim 1 for decreasing wafer scrap rate in the chemical treatment apparatus, wherein the chemical treatment process is selected from a group consisting of a wafer rinsing process and a wet etching process.

7. The method of claim 1 for decreasing wafer scrap rate in the chemical treatment apparatus, wherein the step of determining if the surface of the remaining portion of the chemical treatment liquid in the chemical treatment bath is lower than the standard surface is determined by a lower level indicating sensor installed in the outer bath.

8. The method of claim 1 for decreasing wafer scrap rate in the chemical treatment apparatus, wherein the step of determining if the surface of the remaining portion of the chemical treatment liquid in the chemical treatment bath is lower than the standard surface is determined by a drain time of the chemical treatment liquid.

9. A method for decreasing wafer scrap rate in the chemical treatment apparatus, comprising:
providing a chemical treatment bath, wherein the chemical treatment bath has an inner and an outer bath, the outer being connected with a drain valve, and the chemical treatment bath has a chemical treatment liquid contained;
performing a chemical treatment process by putting a wafer into the chemical treatment liquid; and
when an alarm occur, opening the drain valve of the outer bath for draining the chemical treatment liquid out of the chemical treatment bath, and opening a supply valve of ultra-pure water for supplying the ultra-pure water into the inner bath of the chemical bath.

10. The method of claim 9 for decreasing wafer scrap rate in the chemical treatment apparatus, wherein the chemical treatment liquid is composed of the material selected from a group consisting of SPM, DHF, BOE, APM, and HPM.

11. The method of claim 9 for decreasing wafer scrap rate in the chemical treatment apparatus, wherein the volume of the chemical treatment bath is about 30 liters, and the supply rate of the ultra-pure water is larger than about 30 liters per minute.

12. The method of claim 9 for decreasing wafer scrap rate in the chemical treatment apparatus, wherein the chemical treatment process is selected from a group consisting of a wafer rinsing process and a wet etching process.

13. A method for decreasing wafer scrap rate in the chemical treatment apparatus, comprising:
providing a chemical treatment bath, wherein the chemical treatment bath has an inner and an outer bath, and the chemical treatment bath has a chemical treatment liquid contained;
performing a chemical treatment process by putting a wafer into the chemical treatment liquid; and
when an alarm occurs, using a robot to take out the wafer from the chemical bath and to put the wafer into a rinsing bath having a rinsing liquid, wherein the alarm is resulted from a manufacturing parameter failing to meet a manufacturing standard, while a power supply and the robot are operated normally.

14. The method of claim 13 for decreasing wafer scrap rate in the chemical treatment apparatus, wherein the chemical treatment liquid is composed of the material selected from a group consisting of SPM, DHF, BOE, APM, and HPM.

15. The method of claim 13 for decreasing wafer scrap rate in the chemical treatment apparatus, where the chemical treatment process is selected from a group consisting of a wafer rinsing process and a wet etching process.

16. The method of claim 13 for decreasing wafer scrap rate in the chemical treatment apparatus, wherein the rinsing liquid is ultra-pure water.
